(19) United States
(12) Patent Application Publication
(10) Pub. No.: US 2018/0229440 A1
(43) Pub. Date: Aug. 16, 2018

(54) Method for the Integral Bonding of Two Workpieces

(71) Applicant: Henkel AG & Co. KGaA, Duesseldorf (DE)

(72) Inventors: Pablo Walter, Muenchen (DE); Norman Friedrich, Muenchen (DE); Hendrik Luetzen, Muenchen (DE); Lina Gonzalez, Muenchen (DE); Thomas Haertig, Muenchen (DE)

(21) Appl. No.: 15/953,714

(22) Filed: Apr. 16, 2018

Related U.S. Application Data
(63) Continuation of application No. PCT/EP2016/074678, filed on Oct. 14, 2016.

(30) Foreign Application Priority Data
Oct. 16, 2015 (EP) 15190209.5

(51) Int. Cl. B29C 65/00; B29C 65/40; B29C 65/52; B29C 65/48; B32B 7/12; B32B 27/08

(52) U.S. Cl. CPC B29C 66/91413; B32B 27/08; B29C 66/91221; B29C 65/524; B29C 65/4815; B29C 66/0242; B29C 66/41; B29C 66/712; B29C 66/73116; B29C 66/73117; B29C 66/73921; B29C 66/83411; B29C 66/863; B29C 66/91216; B29C 66/91933; B29C 66/91943; B32B 7/12; B29C 65/40

(57) ABSTRACT

The invention relates to a method for the integral bonding of two workpieces made from different types of thermoplastic polymers with the help of a preferably thermoplastic polymer primer as bonding layer, comprising the following steps: providing a first workpiece made from a thermoplastic polymer having a first edge layer; providing a second workpiece made from a thermoplastic polymer having a second edge layer, said thermoplastic polymer being of a different type to the thermoplastic polymer of the first workpiece; preheating the first edge layer; applying the primer on the preheated first edge layer, wherein, during the application of the primer, the preheated first edge layer has a temperature in the range between the extrapolated onset of the glass transition temperature for amorphous plastics or the peak starting temperature of the melting region for partially crystalline plastics and the step starting temperature of the disintegration of the thermoplastic polymer of the first edge layer; bringing the first edge layer provided with the primer into contact with the second edge layer; and integral bonding of the first edge layer with the second edge layer.

### FIELD

The present invention relates to a method for integrally bonding two workpieces made of dissimilar thermoplastic polymers using a connecting layer.

### BRIEF DESCRIPTION OF RELATED TECHNOLOGY

Integral bonding methods for connecting plastics materials have long been known in the prior art. Workpieces of this kind can be adhesively bonded together by means of an adhesive layer. Alternatively, or additionally, welding techniques or multi-component injection molding techniques can be used to interconnect the workpieces.

The use of welding techniques for connecting plastics materials is disclosed in DE3823817C1, for example. The method described herein for connecting shaped bodies made of polymer materials provides for the bonding surfaces of the shaped body to be melted from the outside and welded together under the application of molding pressure.

DE102012004385A1 discloses another method for connecting shaped parts made of dissimilar thermoplastic polymers, in which method the bonding surfaces of the shaped parts to be welded and made of the different thermoplastic polymers are first treated and/or coated using plasma processes. According to the invention, the functionalized shaped parts are then fed to a suitable welding process in which the shaped parts are plasticized and sealingly connected in a lasting manner by supplying heat in the region of the functionalized bonding surfaces.

In contrast, DE4242059A1 discloses a method for connecting plastics shaped bodies to another plastics component, in which method an intermediate layer is applied to one of the bonding surfaces, resulting in a surface weld being produced between the shaped bodies and the additional plastics component when heat is supplied, and thermoplastic materials such as polyolefin (polypropylene or polyethylene) are used. In order to provide a recycling-friendly connection, the invention provides for plastics components and an intermediate layer of the same material base to be used.

DE102006054936A1 also discloses a similar method for integrally bonding at least two workpieces consisting of thermodynamically incompatible plastics materials, in which method an adhesive weld additive that is at least partially thermodynamically compatible with the workpieces or the monomer composition of which is identical to said workpieces is applied to an edge layer of at least one of the workpieces to be bonded, and the edge layer is then heated to such an extent that the workpieces form an integral connection with each other after the heating process has finished.

### SUMMARY

The problem addressed by the invention is that of demonstrating an improved method for integrally bonding two workpieces made of dissimilar thermoplastic polymers using a connecting layer.

This invention is solved by the features of claim 1.

Advantageous embodiments of the invention are specified in the dependent claims.

The basic concept of the invention is a method for integrally bonding two workpieces made of dissimilar thermoplastic polymers using a preferably thermoplastic polymer primer as a connecting layer, which method contains the following steps:

providing a first workpiece which is made of a thermoplastic polymer and comprises a first edge layer,

providing a second workpiece which is made of a thermoplastic polymer and comprises a second layer, wherein the thermoplastic polymer is dissimilar with respect to the thermoplastic polymer of the first workpiece,

preheating the first edge layer,

applying the primer to the preheated first edge layer, wherein the preheated first edge layer, while the primer is being applied, has a temperature in the range between the extrapolated onset of the glass transition temperature for amorphous plastics materials or the initial peak temperature of the melting range for partially crystalline plastics materials and the initial stage temperature of the decomposition of the thermoplastic polymer of the first edge layer,

bringing the first edge layer provided with the primer into contact with the second edge layer,

integrally bonding the first edge layer to the second edge layer, in particular by using conventional methods for welding plastics materials, for example hot plate welding, hot gas welding, vibration welding, ultrasonic welding, infrared welding and combinations thereof.

### DETAILED DESCRIPTION

The understanding as per DIN 1910-3:1977-09 can be generally used for welding plastics materials. Therefore, welding plastic materials can be understood to mean integrally bonding thermoplastic plastics materials using heat and/or pressure. The heating can be carried out on the basis of contact heating (welding by solid bodies), convection heating (welding by hot gas), radiation heating (welding by beam) and heating by friction (welding by movement), as well as welding by electric current, for example.

According to the invention, an edge layer can be understood to mean a surface region of a workpiece to be bonded, which surface region is arranged in the region of the subsequent bonding zone.

According to the invention, the method can provide a composite workpiece, a design being conceivable which allows a first bonding zone between the first workpiece and the primer and a second bonding zone between the primer and the second workpiece. At the same time, a design is conceivable which allows an overall bonding zone between the first workpiece, primer and the second workpiece.

By means of the method according to the invention, an improved bond strength can be achieved in particular.

According to the invention, two workpieces made of dissimilar thermoplastic polymers are used. Dissimilar thermoplastic polymers are understood to be preferably those thermoplastic polymers that may be difficult to connect or insufficiently connected using conventional welding methods. Unlike similar thermoplastic polymers, differences in the melting temperature, the melting viscosity and the molecular structure of the polymers, for example, can lead to an incompatibility. In addition to a chemical incompatibility, different physical properties can also cause a welded seam that initially seems effective to fail. If the thermal expansions of the two polymers differ, this can cause the workpieces to have no or an insufficient bond strength.

The plastics materials to be bonded or the thermoplastic polymers on which said plastics materials are based can be selected from the following: the plastics materials are thermoplastic plastics materials, the following being mentioned as suitable thermoplastic polymers by way of example: polyoxyalkylenes, polycarbonates (PC), polyesters such as polybutylene terephthalate (PBT) or polyethylene terephthalate (PET), polyolefins such as polyethylene or polypropylene, poly(meth)acrylates, polyamides, vinyl aromatic (co)polymers such as polystyrene, impact-modified polystyrene such as HIPS, or ASA, ABS or AES polymers, polyarylene ethers such as polyphenylene ethers (PPE), polysulfones, polyphenylene sulfides (PPS), polyurethanes, polylactides, halogen-containing polymers, such as polyvinylchloride (PVC), imide group-containing polymers, cellulose esters, silicone polymers and thermoplastic elastomers. Mixtures of different thermoplastic polymers can also be used as materials for the plastics shaped parts. Said mixtures may be single-phase or multiphase polymer blends. The shaped parts to be interconnected may consist of identical or different thermoplastic polymers or thermoplastic polymer blends; the plastics materials preferably comprise a thermoplastic polymer as a main component, in particular accounting for more than 40 wt. %, in particular more than 60 wt. %, preferably more than 70 wt. %, preferably more than 90 wt. % of said one thermoplastic polymer, in each case based on the polymer proportion of the plastics material, in particular in each case based on the total plastics material (with fillers).

Polyamide plastics materials are suitable as plastics materials to be bonded, for example. The polyamide plastics material is preferably a thermoplastic polyamide. The amide-based thermoplastic polymers include, for example: polyamide 6, a homopolymer of epsilon-caprolactam (polycaprolactam); polyamide 11, a polycondensate of 11-aminoundecanoic acid (poly-11-aminoundecanoic amide); polyamide 12, a homopolymer of omega-laurolactam (polylaurolactam); polyamide 6.6, a homopolycondensate of hexamethylenediamine and adipic acid (polyhexamethylene adipamide); polyamide 6.10, a homopolycondensate of hexamethylenediamine and sebacic acid (polyhexamethylene sebacamide); polyamide 6.12, a homopolycondensate of hexamethylene diamine and dodecanedioic acid (polyhexamethylene dodecanamide) or polyamide 6-3-T, a homopolycondensate of trimethylhexamethylene diamine and terephthalic acid (polytrimethyl hexamthylene terephthalic amide), poly(p-phenylene-terephthalic amide) or poly(m-phenylene terephthalic amide) of phenylene diamine and terephthalic acid, polyphthalamides PPA of different diamines and terephthalic acid and mixtures thereof.

Optically transparent polyamides comprise microcrystalline polyamides containing linear aliphatic dicarboxylic acids and cycloaliphatic diamines, amorphous polyamides containing linear aliphatic dicarboxylic acids and cycloaliphatic diamines and optionally lactams or amino carboxylic acids, amorphous polyamides containing terephthalic acid and cycloaliphatic or branched aliphatic diamines and optionally lactams or amino carboxylic acids or amorphous polyamides containing isophthalic acid and cycloaliphatic or linear or branched aliphatic diamines and optionally lactams or amino carboxylic acids. Suitable optically transparent polyamides are, for example, amides of dodecanedioic acid and an isomer mixture of 4,4′-bis(aminocyclohexyl) methane, of terephthalic acid and the isomer mixture of 2,2,4- and 2,4,4-trimethylhexamethylene diamine, of dodecanedioic acid and the isomer mixture of 3,3′-dimethyl-4,4′-bis(aminocyclohexyl)-methane, of lauolactam, isophthalic acid and the isomer mixture of 3,3′-dimethyl-4,4′-bis(aminocyclohexyl)-methane or of tetradecanedioic acid and the isomer mixture of 3,3′-dimethyl-4,4′-bis(aminocyclohexyl)-methane or of epsilon caprolactam or omega-laurolactam.

Preferred polyamides are selected from the group consisting of polyamide 6, polyamide 6.6, polyamide 6.10, polyamide 6.12, polyamide 10.10, polyamide 11, polyamide 12, polyamide 10.12, polyphthalamides, optically transparent polyamides or mixtures based on said polyamides. Particularly preferred polyamides are selected from polyamide 6, polyamide 6.6, polyamide 12, polyphthalamides, optically transparent polyamides and mixtures thereof, in particular polyamide 6, polyamide 6.6 and mixtures thereof.

Poly(meth)acrylate is a synthetic, preferably transparent, thermoplastic plastics material. Preferred poly(meth)acrylates are composed of 50 to 100 wt. %, in particular 70 to 100 wt. % acrylate and/or methacrylate, the (meth)acrylate units preferably being esterified with a C1 to C12 alkyl functional group, in particular C1-C4, preferably methyl functional group. The notation poly(meth)acrylate specifies that the polymer is composed of acrylate and/or methacrylate. Respectively, the notation (meth)acrylate specifies that this can be both an acrylate and a methacrylate. Particularly preferably, the poly(meth)acrylate is a polymethyl methacrylate (PMMA, also known colloquially as acrylic glass or Plexiglas). Preferred poly(meth)acrylates are composed of from 50 to 100 wt. %, in particular 70 to 100 wt. % methyl methacrylate.

As comonomers for the composition of poly(meth)acrylate, in particular of polymethyl methacrylate, meth(acrylic acid), in particular acrylic acid, and alkyl esters thereof having 1 to 12 carbon atoms, in particular 1 to 4 carbon atoms in the alkyl functional group, and acrylonitril and/or methacrylonitril, acrylamide and/or methacrylamide, styrene and/or maleic acid anhydride may be considered in the first instance. Thermoplastically and thermoelastically deformable plastics materials are preferred. Preferred thermoplastic polymethylmethacrylate plastics materials have weight-average molar masses (weight average Mw) of more than 50,000 g/mol, in particular more than 100,000 g/mol. The thermoplastic poly(meth)acrylate plastics materials, in particular polymethyl methacrylate plastics materials preferably have a weight-average molar mass (weight average Mw) of less than 2,000,000 g/mol, in particular less than 1,000,000 g/mol, preferably less than 500,000 g/mol. Particularly preferred thermoplastic poly(meth)acrylate plastics materials, in particular polymethyl methacrylate plastics materials have weight-average molar masses (weight average Mw) of from 50,000 g/mol to 250,000 g/mol, e.g. from approximately 100,000 g/mol to approximately 180,000 g/mol for the injection molding.

Suitable polyolefin plastics materials are in particular thermoplastic polyolefin plastics materials. A polyolefin plastics material is based on polyolefin-based polymers such as homopolymers and copolymers of alpha olefins. The polyolefin-based polymers can be selected from the group consisting of poly-alpha-olefin homopolymers based on ethylene, propylene and/or butylene, in particular homopolymers of ethylene or propylene, and poly-alpha-olefin copolymers based on ethene, propene, 1-butene, 1-hexene and 1-octene, in particular ethylene/alpha-olefin and propylene/alpha-olefin copolymers, preferably copolymers of ethylene or propene with 1-butene, 1-hexene, 1-octene or a combination thereof. In particular, the polyolefin plastics materials are preferably selected from polyethylene (in particular high-density (HD) polyethylene, medium-density (MD) polyethylene, low-density (LD) polyethylene, ultra-high molecular weight (UHMW) polyethylene and linear low-density (LLD) polyethylene, preferably HD polyethylene, MD polyethylene or LD polyethylene) and polypropylene plastics materials. The polyolefin plastics material is particularly preferably a polypropylene plastics material.

The polyolefin polymers, in particular polypropylene polymers, preferably have a weight-average molar mass (weight average Mw) of more than 10,000 g/mol, in particular more than 20,000 g/mol preferably more than 50,000 g/mol, particularly preferably more than 100,000 g/mol. The polyolefin polymers, in particular polypropylene polymers, preferably have a weight-average molar mass (weight average Mw) of less than 2,000,000 g/mol, in particular less than 1,000,000 g/mol, preferably less than 500,000 g/mol. Particularly preferred polyethylene polymers have a weight-average molar mass (weight average Mw) of from 50,000 g/mol to 1,000,000 g/mol, in particular from 200,000 g/mol to 500,000 g/mol. Other preferred polyethylene polymers (UHMW PE polymers) have a weight-average molar mass of more than 2,000,000 g/mol, in particular from 4,000,000 g/mol to 6,000,000 g/mol. Particularly preferred polyolefin polymers, in particular polypropylene polymers, have a weight-average molar mass (weight average Mw) of from 50,000 g/mol to 250,000 g/mol.

Suitable polyester plastics materials are likewise known per se and described in the literature. Preferred polyester plastics materials comprise a polyester having an aromatic ring derived from an aromatic dicarboxylic acid in the main chain. The aromatic ring can also be substituted, for example by halogen such as chlorine or bromine or by C1-C4 alkyl groups such as methyl, ethyl, i- or n-propyl groups or n-, i- or t-butyl groups. The polyesters can be prepared in a manner known per se by reacting aromatic dicarboxylic acids, the esters thereof or other ester-forming derivatives thereof with aliphatic dihydroxy compounds. Preferred dicarboxylic acids include naphthalene dicarboxylic acids, orthophthalic acids, terephthalic acids and isophthalic acids or mixtures thereof. Up to 30 mol. % of the aromatic dicarboxylic acids can be replaced by aliphatic or cycloaliphatic dicarboxylic acids such as adipic acid, azelaic acid, sebacic acid, dodecanoic acid and cyclohexanedicarboxylic acid. Of the aliphatic dihydroxy compounds, diols having 2 to 8 carbon atoms, in particular 1,2-ethanediol, 1,4-butanediol, 1,6-hexandiole, 1,4-hexanediol, 1,4-cyclohexanedimethylol and neopentyl glycol or mixtures thereof are preferred. Particularly preferred polyesters include polyalkylene terephthalates which are derived from alkanediols having 2 to 6 carbon atoms.

The polyester plastics materials are preferably selected from the group of polyethylene terephthalate (PET), polyethylene naphthalate, polybutylene naphthalate and polybutylene terephthalate (PBT) plastics materials and mixtures thereof, in particular polyethylene terephthalate (PET) and polybutylene terephthalate (PBT) plastics materials and mixtures thereof.

Suitable polycarbonate plastics materials are preferably thermoplastic plastics materials which can be formally described as polyesters of carbonic acid. Polycarbonates can in principle be prepared by polycondensation of phosgene with diols, preferably bisphenols. Preferred polycarbonates are aromatic polycarbonates. Aromatic polycarbonates are those which are composed of at least one aromatic monomer. Preferred polycarbonate plastics materials are plastics materials based on bisphenol, in particular bisphenol A and bisphenol F. For the bisphenol-based polycarbonates, the diol component consists of up to 50 wt. %, in particular up to 70 wt. %, preferably up to 90 wt. %, preferably up to 100 wt. % bisphenol, in particular bisphenol A and/or bisphenol F.

Likewise suitable plastics materials are plastics materials containing at least one vinyl aromatic polymer, in particular copolymer, of monomers selected from styrene, chlorostyrene, alpha-methylstyrene and para-methylstyrene. In minor proportions, vinyl aromatic copolymers (preferably no more than 20, in particular no more than 8 wt. %) and also comonomers such as (meth)acrylonitrile or (meth)acrylic acid ester can be part of the composition. Particularly preferred vinyl aromatic polymers are polystyrene, styrene acrylonitrile copolymers (SAN), polystyrene methyl methacrylate (SMMA) and impact-modified polystyrene (HIPS=High Impact Polystyrene). Of course, mixtures of said polymers can also be used.

Very particularly preferred vinyl aromatic polymers are ASA, ABS and AES polymers (ASA=acrylonitrile styrene acrylic ester, ABS=acrylonitrile butadiene styrene, AES=acrylonitrile EPDM rubber styrene). These impact-modified vinyl aromatic polymers contain at least one rubber-elastic graft polymer and one thermoplastic polymer (matrix polymer). A styrene/acrylonitrile polymer (SAN) is generally used as a matrix material. Graft polymers are preferably used which contain a diene rubber based on dienes such as butadiene or isoprene (ABS), an alkyl acrylate rubber based on alkyl esters of acrylic acid such as n-butyl acrylate and 2-ethylhexyl acrylate, an EPDM rubber based on ethylene, propylene and a diene or mixtures of said rubbers or rubber monomers as a rubber.

The weight-average molecular weight of said vinyl aromatic polymers is in particular of from 1,500 to 2,000,000 g/mol, preferably from 70,000 to 1,000,000 g/mol.

In addition, the plastics material can be a mixture of at least one polycarbonate and at least one vinyl aromatic polymer, preferably the above-mentioned ones. Said mixture preferably contains more polycarbonate than vinyl aromatic polymers, in particular SMMA, SAN, ASA, ABS and/or AES, preferably ABS. The ratio of polycarbonate, in particular aromatic polycarbonate, to vinyl aromatic polymer, in particular SMMA, SAN, ASA, ABS and/or AES, is preferably from 1:1 to 100:1, in particular from 2:1 to 50:1, preferably from 3:1 to 10:1.

Polyoxyalkylene homopolymers or copolymers, in particular (co)polyoxymethylenes (POM) are also suitable for producing the plastics materials. Very generally, said polymers have at least 50 mol. % of repeated —CH2O units in the polymer main chain. Homopolymers are generally produced by polymerization of formaldehyde or trioxane, preferably in the presence of suitable catalysts. Polyoxymethylene copolymers and polyoxymethylene terpolymers are preferred. The preferred polyoxymethylene (co)polymers have melting points of at least 150° C. and molecular weights (weight average) Mw in the range of from 5,000 to 200,000, preferably from 7,000 to 150,000 g/mol. End-group stabilized polyoxymethylene polymers which have C—C bonds at the chain ends are particularly preferred.

Polyarylene ethers are understood to be preferably polyarylene ethers per se, polyarylene ether sulfides, polyarylene ether sulfones or polyarylene ether ketones. The arylene groups thereof may be the same or different and signify, independently of one another, an aromatic functional group having 6 to 18 carbon atoms. Examples of suitable arylene functional groups are phenylene, biphenylene, terphenylene, 1,5-napthylene, 1,6-napthylene, 1,5-anthrylene, 9,10-anthrylene or 2,6-anthrylene. Of these, 1,4-phenylene and 4,4′-biphenylene are preferred. Said aromatic functional groups are preferably not substituted. However, they can carry one or more substituents.

In addition, polyurethanes, polyisocyanurates and polyureas are suitable materials for producing the plastics shaped parts. Soft, medium-hard or hard thermoplastic or crosslinked polyisocyanate polyaddition products, for example polyurethanes, polyisocyanurates and/or polyureas are generally known. The production thereof is described in many ways and is usually carried out by reacting isocyanates with isocyanate-reactive compounds under generally known conditions. The reaction is preferably carried out in the presence of catalysts and/or auxiliaries.

Isocyanates include per se known aromatic, arylaliphatic, aliphatic and/or cycloaliphatic organic isocyanate, preferably diisocyanates.

Generally known compounds having a molecular weight of from 60 to 10,000 g/mol and a functionality with respect to isocyanates of from 1 to 8, preferably 2 to 6 (functionality approximately 2 in the case of thermoplastic polyurethanes), for example polyols such as polyether polyols, polyester polyols and polyether polyester polyols having a molecular weight of from 500 to 10,000 g/mol and/or diols, triols and/or polyols having molecular weights of less than 500 g/mol, can be used as isocyanate-reactive compounds.

Polylactides, i.e. polymers of lactic acid, are known per se and can be produced according to methods that are known per se.

In addition to polylactide, copolymers or block copolymers based on lactic acid and additional monomers can also be used. Linear polylactides are mostly used. However, branched lactic acid polymers can also be used. Polyfunctional acids or alcohols can be used as branching agents, for example.

Suitable halogen-containing polymers include, for example, polymers of vinyl chloride, in particular polyvinyl chloride (PVC) such as hard PVC and soft PVC and copolymers of vinyl chloride such as PVC-U shaped bodies. In addition, fluorine-containing polymers may be considered, in particular polytetrafluorethylene (PTFE), tetrafluorethylene-perfluorpropylene copolymers (FEP), copolymers of tetrafluorethylene with perfluoralkyl vinyl ether, ethylene-tetrafluorethylene-copolymers (ETFE), polyvinylidene fluoride (PVDF), polyvinylfluoride (PVF), polychlorotrifluorethylene (PCTFE), and ethylene-chlorotrifluorethylene copolymers (ECTFE).

Imide group-containing polymers are in particular polyimides, polyetherimides and polyamide-imides.

Suitable cellulose esters are, for instance, cellulose acetate, cellulose acetobutyrate and cellulose propionate.

In addition, silicone polymers may also be considered as thermoplastic polymers. Silicone rubbers are suitable in particular. These are typically polyorganosiloxanes that have groups capable of cross-linking reactions.

Finally, the family of thermoplastic elastomers (TPE) can also be used. TPE can be processed like thermoplastic polymers, but have rubber-elastic properties. TPE block copolymers, TPE graft copolymers and segmented TPE copolymers of two or more monomer building blocks are suitable. Particularly suitable TPEs are thermoplastic polyurethane elastomers (TPE-U or TPU), styrene-oligo block copolymers (TPE-S) such as SBS (styrene-butadiene-styrene block copolymers) and SEBS (styrene-ethylene-butylene-styrene block copolymers, which can be obtained by hydrogenating SBS), thermoplastic polyolefin elastomers (TPE-O), thermoplastic polyester elastomers (TPE-E), thermoplastic polyamide elastomers (TPE-A) and in particular thermoplastic vulcanizate (TPE-V).

According to the invention, a preferably thermoplastic polymer primer is used in the method as a connecting layer. Primers are preferably used which are adapted to the respective workpieces and which preferably contain at least one polymer selected from the following polymer groups: polyolefins, polyamides, polyacrylates, polystyrenes, polycarbonates and polyethers.

The preferably thermoplastic primer is preferably characterized in that strong intermolecular interactions, diffusion processes and even chemical bonds with the workpieces can be achieved at the interfaces. Said interactions can allow an improvement in the integral bonding method. In addition, the workpieces preferably differ from the primer in the chemical composition thereof.

The primer is a welding aid which is preferably applied to at least one of the surfaces of the workpieces to be welded in the region of the subsequent bonding zone (or weld zone) as a pretreatment layer. The primer is not to be understood as an adhesive, cleaning agent or the like, but rather the primer is a welding aid, by means of which the bonding partners in the bonding zone are made compatible with one another, thus producing an integral and frictional connection between the workpieces to be welded in the bonding zone during bonding.

By using a corresponding primer, containing a polymer according to the invention, the different plastics materials can be compatibilized in the bonding zone during welding and thus a stable and long-lasting connection is achieved. Without the use of a corresponding primer, no or very limited strength of the welded connection could be achieved. The bonded substrates preferably have a tensile strength of more than 2 MPa, in particular more than 5 MPa, preferably more than 7 MPa. The tensile strength is determined using a traction speed of 5 mm/s, the samples to be measured that have a geometry of 130 mm×68 mm×3 mm being welded edge to edge to the 130-mm×3 mm surface using the connecting layer.

All of the polymers already mentioned above for the plastics materials may be considered as suitable polymers for the primer.

In addition to the polymer according to the invention, the primer can preferably also contain at least one additional polymer which is different from the first polymer according to the invention, in particular which differs in the polymer composition. The at least one additional polymer is preferably compatible with at least one of the two plastics materials to be welded and with the first polymer according to the invention in the primer.

The content of the additional polymer in the primer is preferably of from 1-40 wt. %, in particular 5-30 wt. %, particularly preferably 10-20 wt. %, in each case based on the total weight of the primer. The content of the additional polymer in the polymer content of the primer is preferably from 5-70 wt. %, in particular 20-60 wt. %, particularly preferably 30-50 wt. %, in each case based on the total weight of the primer (primer without solvent and without filler). In a preferred embodiment, the primer does not contain an additional polymer, but only has the first polymer according to the invention.

In addition to the first polymer according to the invention and the additional polymer, the primer can also contain a solvent, in particular an organic solvent. The primer preferably has a solvent content of from 10-90 wt. %, in particular 50-85 wt. %, particularly preferably 60-80 wt. %, in each case based on the total weight of the primer.

Suitable solvents are all conventional solvents, for example water, alcohols, ketones such as methyl isobutyl ketone (MIBK) or cyclohexanone (CH), ethers such as diethyl ether or tetrahydrofurane (THF), esters such as acetic acid ethyl ester, or carbonates such as dimethyl or dipropyl carbonate, toluene, xylene or mixtures thereof.

In a preferred embodiment, the primer contains organic solvents. Particularly preferred solvents are solvents that have a vapor pressure at 20° C. of from 1 to 600 hPa, in particular 2 to 200 hPa, particularly preferably 5 to 20 hPa. Solvents that have a corresponding vapor pressure have proven particularly advantageous in minimizing or preventing bubble formation in the primer layer during evaporation. The primer particularly preferably contains a solvent selected from tetrahydrofurane, methyl isobutyl ketone, cyclohexanone and mixtures thereof, the primer more preferably contains tetrahydrofurane or a mixture of methyl isobutyl ketone and cyclohexanone. If a mixture of methyl isobutyl ketone and cyclohexanone is used as a solvent, said mixture preferably contains from 10-50 wt. %, in particular 20-35 wt. % cyclohexanone, in each case based on the total mixture of solvent.

If organic solvents are used, the total polymer content of the primer is preferably from 10-90 wt. %, in particular 15-50 wt. %, particularly preferably 20-40 wt. %, in each case based on the total weight of the primer. The total polymer content corresponds to the content of all the polymers used in the primer, in particular the copolymers according to the invention and the above-described additional polymers.

In another preferred embodiment, the primer is present in the form of an aqueous dispersion or emulsion. In this case, the polymer according to the invention or, if present, the additional polymers is (are) emulsified or dispersed in water. In this case, the total polymer content of the primer is preferably from 5-90 wt. %, 20-70 wt. %, particularly preferably 30-55 wt. %, in each case based on the total weight of the primer. It is advantageous for the aqueous dispersion/emulsion for the polymer component to consist substantially of only the polymer according to the invention and the optionally present above-mentioned additional polymer, only the polymer according to the invention. According to the invention, the term “substantially” is understood to mean if the polymer component consists of more than 95 wt. %, preferably more than 97 wt. %, most particularly preferably more than 99 wt. % of the polymer according to the invention and the optionally present above-mentioned additional polymer, only the polymer according to the invention.

In another preferred embodiment, the primer is substantially free of solvents.

In addition to the copolymer according to the invention, the above-mentioned additional polymers and a solvent, the primer may contain additional components, for example fillers, (fluorescent) dyes and pigments, rheological aids, defoaming aids, wetting aids, stabilizers or plasticizers. However, apart from dyes and pigments, the primer is preferably substantially free of additional components, substantially free of any other components. According to the invention, the term “substantially free of” is understood to mean if the primer contains less than 5 wt. %, preferably less than 1 wt. %, most particularly preferably less than 0.1 wt. % of the respective substances, does not contain the respective substances.

In an advantageous development, a primer is used which is selected and adapted to the method such that the application to a heated and/or hot edge layer having a temperature that is lower than the decomposition temperature of the particular primer does not affect the inner chemical crosslinking of the primer.

Preheating the first edge layer of the first workpiece is provided according to the invention. For the preheating, a person skilled in the art can use known aids and techniques that are suitable for the intended purpose. In particular, the use of hot gas or plasma is suitable for the preheating. Preheating by means of radiation, in particular infrared radiation or laser radiation is also conceivable. A heating element or a heated tool can also be used to preheat the first edge layer. Finally, preheating in a furnace or a heated chamber is also conceivable. It is also conceivable to preheat the entire workpiece and thus also said edge layer. However, alternatively or additionally, preheating only the edge layer itself is also possible.

In an advantageous development of the invention, the first edge layer is preheated in such a way and for such a time that the temperature of the first edge layer or of a bonding surface of the first edge layer for amorphous plastics materials is preferably in the range between the extrapolated onset of the glass transition temperature (T_{ei,g}) and the initial stage temperature (T_{ini,z}) of the decomposition of the thermoplastic polymer from which the chemical composition of the thermoplastic polymer is damaged and from which said polymer begins to decompose. For partially crystalline plastics materials, the temperature is preferably in the range between the initial peak temperature (T_{ini,m}) of the melting range and the initial stage temperature (T_{ini,z}) of the decomposition of the thermoplastic polymer. In all cases, the first edge layer is preferably preheated in such a way and only for such a time that the workpiece is itself deformed at most in the region of the edge layer.

Said glass transition temperature (T_{ei,g}) depends on a used amorphous thermoplastic polymer of the first workpiece, the extrapolated onset of the glass transition temperature (T_{ei,g}) and also the glass transition temperature (T_{m,g}) (midpoint temperature) being understood and also being determined for the particular thermoplastic polymer according to DIN EN ISO 11357-1:2010-03 and DIN EN ISO 11357-2:2014-07. The initial peak temperature (T_{ini,m}) depends on a used partially crystalline thermoplastic polymer of the first workpiece, the initial peak temperature (T_{ini,m}) of the melting range and the melting peak temperature (T_{PM}) being understood and also being determined for the particular thermoplastic polymer according to DIN EN ISO 11357-3:2013-04.

The initial stage temperature (T_{ini,z}) of the decomposition depends on the used thermoplastic polymer of the first workpiece, the initial stage temperature (T_{ini, z}) of the decomposition and the decomposition temperature (T_{Z}) being understood and also being determined for the particular thermoplastic polymer according to DIN 51005:2005-08 and DIN 51006:2005-07.

In this case, the preheating can be carried out as described above, it being conceivable for the temperature of the first edge layer during the preheating to be continuously recorded, in order to allow the preheating to be controlled using the recorded value. This is preferably carried out using a contactless temperature measurement (pyrometry), for example using a pyrometer.

According to the invention, the primer is applied to the preheated first edge layer, wherein said first edge layer or a bonding surface of the first edge layer, while the primer is being applied, preferably has a temperature in the range between the extrapolated onset of the glass transition temperature (T_{ei,g}) for amorphous plastics materials and the initial stage temperature (T_{ini,z}) of the decomposition of the thermoplastic polymer of the first edge layer. When using partially crystalline plastics materials, the temperature of the first edge layer or a bonding surface of the first edge layer, while the primer is being applied is, according to the invention, in the range between the initial peak temperature (T_{ini,m}) and the initial stage temperature (T_{ini,z}) of the decomposition of the thermoplastic polymer of the first edge layer. Said temperatures are understood as per the above-mentioned temperatures and correspondingly determined for the respective materials.

In an advantageous development of the invention, the primer is applied to the preheated first edge layer, said first edge layer having, while the primer is being applied, a temperature that is lower than the decomposition temperature (T_{Z}) of the primer. The decomposition temperature (T_{Z}) of the primer is understood to mean an above-mentioned decomposition temperature (T_{Z}) which can be determined according to the particular material to be used for the primer.

In an advantageous development, the spacing between the heating device during the preheating and the surface of the first workpiece, in particular the first edge layer to be preheated, in particular the heat-dissipating region of the heating device or the heat-leaking region of the heating device or the effective surface of the heating device to be preheated or the region of the heating device opposite the first edge layer, is in a range of from 0.5 mm to 100 mm, preferably in the range of from 1 mm to 60 mm. It is also conceivable for heating to take place by means of and/or during contact in particular of the first edge layer by the heating element of the heating device.

Another advantage is selecting the material for the first workpiece and adjusting the process parameters to the first workpiece such that the first edge layer is melted during the preheating and that a melt layer is produced in the first edge layer during the preheating. In a preferred embodiment, the thickness of the melt layer is particularly preferably in the range of from 0.05 mm to 6 mm, preferably in the range of from 0.1 mm to 3 mm. A melt layer of this kind can lead to better adhesion and/or diffusion and/or interaction of the molecules and, in conjunction with a certain flow, to an improved connecting layer. If the boundary layer of the first workpiece is in the molten state, interactions or even chemical bonds with the primer may occur. The melt layer can depend in particular on the component geometry and the particular component design. The process parameters are preferably adjusted and/or selected such that no deformation of the components occurs. The temperature differences between the edge layer and the primer to be applied are preferably equalized by suitable measures and/or method steps. In this case is it conceivable in particular to preheat the primer before it is applied in order to reduce the temperature difference between the preferably thermoplastic primer and the first edge layer. This can counteract the rapid cooling of the first edge layer between the process steps, for example.

Preferably before the step of preheating the first edge layer, the first edge layer is optionally pretreated. Alternatively, or additionally, the second edge layer may also be pretreated. Cleaning by means of a solvent or an alkaline (for example) plastics cleaner is also conceivable as a possible pretreatment, for example. Mechanical pretreatment can also be used, in particular by means of scratching, sanding, brushing or blasting. Conceivable chemical pretreatments are in particular acid cleaning or using reactive gasses. In addition, using a thermal, chemical and/or physical pretreatment could be proven expedient, in particular using a gas flame or plasma arc. Alternatively, or additionally, electrical pretreatment by means of corona discharge, in which the first edge layer and/or the second edge layer is exposed to an electrical corona discharge, can thus cause polar molecules to be formed on the corresponding surface. Another possibility is plasma treatment, preferably using a plasma nozzle for pretreating the edge layer, in particular in order to achieve activation and/or cleaning of the corresponding surface. At the same time, a coating using plasma may also prove to be expedient. Another possibility is flame treating the edge layer in order to increase the surface tension for suitable workpieces. Another type of pretreatment is exposure to UV radiation, electron radiation, radioactive radiation or irradiation by laser. Finally, the pretreatment can be carried out in the form of a coating, in particular by means of a coat of paint or an adhesion promoter. It is also conceivable to pretreat the first workpiece or the edge layers of the first workpiece with a longer time interval before the preheating. It is thus conceivable, for example, to carry out the pretreatment as part of the manufacturing process of the first workpiece, in order to be able to further process a pretreated workpiece in the method according to the invention.

There are various possibilities for the manner in which the preferably thermoplastic primer is applied according to the invention following the preheating. For example, and in particular in the industrial field, application using an automated application aid, in particular using a dosing robot, is conceivable. In this case, said dosing robot may be equipped with a needle sensor and/or a height sensor, in order to be able to carry out complex dosing. The primer may also be applied by means of injection molding by the material for the subsequent primer being plasticized in an injection-molding machine and injected under pressure into the mold containing the first workpiece that comprises the first edge layer. Alternatively, a film application is conceivable, a film consisting of a material of the primer first being produced in a first step using film blowing or flat-film extrusion. The film can then be cut into any shape by means of a cutting or punching process, for example, and applied to the first edge layer in a further step following the mentioned preheating. In this case, the use of films/sheets having a thickness in the range of from 1 μm-5,000 μm has proven to be expedient. Additional conceivable application options are extrusion welding, in which a thermoplastic material is present in the form of a welding wire or can be melted in an extruder and applied to the first edge layer in molten form. Providing the material for the primer in the form of a welding wire is also possible in order to allow application by means of hot-air welding. Another option is to apply the primer using a spraying process. Pretreatment and/or preheating and/or locally varying temperature control of the injection mold is also possible during application by means of injection molding. Of course, other types of application that are known to a person skilled in the art and suitable for the specific use are also conceivable.

Another advantage is the additional heating or heating of the first edge layer while the primer is being applied, in particular in order to prevent a temperature drop of the first edge layer between the preheating and the application of the primer. This can be carried out by the above-mentioned method step for preheating, which can be continued during the application for reasons of simplicity. Alternatively, or additionally, additional heating in particular by means of an additional method step is possible. It could be proven expedient, for example, to simultaneously heat the first edge layer, for example by simultaneously exposing the first edge layer to radiation, forced convection or contact heating during application, in order to prevent a temperature drop of the first edge layer after the preheating.

In an advantageous development, the primer is applied such that the layer of primer having a thickness in the range of from 1 μm to 5 mm, preferably in the range of from 10 μm to 3 mm is arranged on the first edge layer. In this case, the thickness of the primer is understood to mean the material thickness of the primer on the first edge layer.

Another advantage is applying the primer to the first edge layer using a dosing device under relative movement between the first edge layer and the dosing device, the first edge layer to which the primer is applied being preheated by means of a heating device before the primer is applied under relative movement between the first edge layer and the heating device, the primer being applied via the dosing device when the first edge layer is in the preheated state.

In this case, it has proven particularly advantageous for the heating device to be guided over the first edge layer during preheating at a speed in the range of from 10 mm/min to 100 m/min, preferably in the range of from 10 mm/min to 30 m/min.

It may also be advantageous for the heating device to lead the dosing device preferably at a defined and constant spacing. Particularly advantageous is an implementation of the method in which the primer is applied to the first edge layer by means of a dosing device under relative movement of the dosing device and the first edge layer in the range of from 10 mm/min to 100 m/min, preferably in the range of from 10 mm/min to 30 m/min, said edge layer to which the primer is applied being preheated by means of a heating device before the primer is applied under relative movement of the heating device and the first edge layer, the heating device preferably simultaneously leading the dosing device or a nozzle of the dosing device in order to apply the primer in a time interval in the range of from 0.1 s-10 s.

In this case it has proven to be particularly advantageous to use a coating unit consisting of a dosing device and a heating device. In this case, a coating unit can be understood in particular to mean a unit that provides a fixed connection between the heating device and the dosing device such that the heating device leads the dosing device preferably at a defined and constant spacing during the relative movement, in order to ensure that the first edge layer is preheated immediately before the primer is applied. Of course, being able to adjust the spacing or adjusting the volume flow or nozzle diameter of the medium, in particular by means of suitable mechanical, electromechanical or even pneumatically operated adjusters, is also conceivable here.

However, the coating unit may also be understood to be a heating device and a dosing device as two assemblies that are completely separate from each other but enter into the same or substantially the same relative movement with respect to the workpiece, in order to ensure that the application location of the primer is preheated immediately before the primer is applied.

In an advantageous embodiment, the heating device and the dosing device enter into a primary relative movement or basic direction with respect to the workpiece and, although said movement is substantially the same, at least one of the two mentioned devices undergoes, in addition to said primary relative movement, an additional relative movement with respect to the workpiece. The heating device and/or the dosing device can thus enter into one or more secondary relative movements, for example, in addition to the primary relative movement in which the primer can also be applied. For example, in particular the heating device and/or the dosing device can enter into or undergo a secondary relative movement that circles or meanders around the primary relative movement.

In this case, the workpiece, on the one hand, or the heating device and the dosing device or both devices together as a coating unit, on the other hand, can be moved. In this case, it is possible for the heating device and the dosing device or both devices together as a coating unit, on the one hand, or the workpiece, on the other hand, to be idle or to be moved in a different direction together with the relevant moving part.

In an advantageous development, a primary relative movement is carried out at a speed in a range of from 10 mm/min to 100 m/min, preferably in the range of from 10 mm/min to 30 m/min, resulting, in particular also by means of a suitable design of the heating device, for example, in dwell times of the workpiece within the heating area of the heating device that are as short as possible, in particular in a range of from 1 s-60 s. Said heating area can be understood to mean a region around the heating device which has an influence on the temperature of the relevant edge layer in the sense of a temperature increase. Too much heating and damaging or impairing the workpiece can thus be prevented, for example.

In addition, it may be proven advantageous, in particular for connecting the dosing device and/or the heating device in existing production lines, to equip the heating device with a bus interface, in particular a Profibus or a real-time ethernet interface.

After said primer has been applied, it is provided according to the invention that the second edge layer is brought into contact with the primer. Here, securing the two workpieces to each other may be proved expedient, in particular using clamping devices or similar securing aids known to a person skilled in the art.

Before the step of bringing the second edge layer into contact with the primer, the second edge layer can of course optionally be pretreated. In this case, in particular all of the above-described pretreatment techniques are conceivable. It is also conceivable to pretreat the second workpiece or the edge layers of the second workpiece with a longer time interval before the contact. It is thus conceivable, for example, to carry out the pretreatment already as part of the manufacturing process of the second workpiece, in order to be able to further process a pretreated workpiece in the method according to the invention. The pretreatment of the second workpiece can also include applying a primer to the second edge layer. A thermoplastic primer is preferably applied to the second edge layer for this purpose. In this case, preheating the second edge layer before applying the preferably thermoplastic primer is preferably also conceivable. The above embodiments relating to the primer or the preferably thermoplastic primer used for the first edge layer supplement in this respect the variants described herein for the corresponding pretreatment of the second edge layer. The same applies in particular to the preheating of the or the application of the preferably thermoplastic primer to the second edge layer itself. In this respect, the above embodiments supplement the disclosure at this point.

According to the invention, the above-described contact between the second edge layer and the primer is followed by a bonding process in which the treated and/or coated bonding partners are plasticized by supplying heat and preferably integrally interconnected under the effect of pressure. For said integral connection between the second edge layer and the primer, it is conceivable for heat to be supplied by means of thermal conduction, for example by means of heated tool welding and/or hot-impulse welding; by means of friction, in particular ultrasonic welding, friction/vibration welding or high-frequency, microwave or induction welding; by means of convection, for example hot gas welding; by means of radiation, for example infrared welding, laser butt welding or laser transmission welding or even by means of a combination of two or more of these techniques.

Another basic concept of the invention is the use of a coating unit for applying a primer as a connecting layer to an edge layer of a workpiece, comprising a dosing device for applying a primer and a heating device for preheating the workpiece before the primer is applied. A coating unit of this kind is suitable, for example, for the above-described method. The above-described advantageous embodiments of the dosing device, heating device and also of the coating unit may also be applied here as preferred embodiments and supplement in this respect this device-related section.

Another advantage is that of connecting the dosing device and the heating device such that a defined spacing between the dosing device and the heating device is maintained during a relative movement between the coating unit and the workpiece. This can be carried out, for example, by means of the design of the coating unit as described above as part of the method. In this case, in particular a fixed connection between the heating device and the dosing device can be provided such that the heating device leads the dosing device at a fixed spacing during the relative movement, in order to ensure that the first edge layer is preheated immediately before the primer is applied. Of course, being able to adjust the spacing, in particular by means of suitable mechanical, electromechanical or even pneumatically operated adjusters, is also conceivable here. Alternatively, or additionally, it is also conceivable to preheat the entire workpiece and thus also said edge layer preferably simultaneously to the application.

### BRIEF DESCRIPTION OF THE DRAWINGS

By way of example, the invention is described using the following drawings, in which:

FIG. 1 is a sectional view through a first workpiece and a rear view of a coating unit for implementing a part of the method according to the invention,

FIG. 2 is a side view of the coating unit from FIG. 1 during the implementation of a part of the method according to the invention,

FIG. 3 is a side view of a welding device during the implementation of a part of the method according to the invention,

FIG. 4 is a side view of an alternative welding device during the implementation of a part of the method according to the invention.

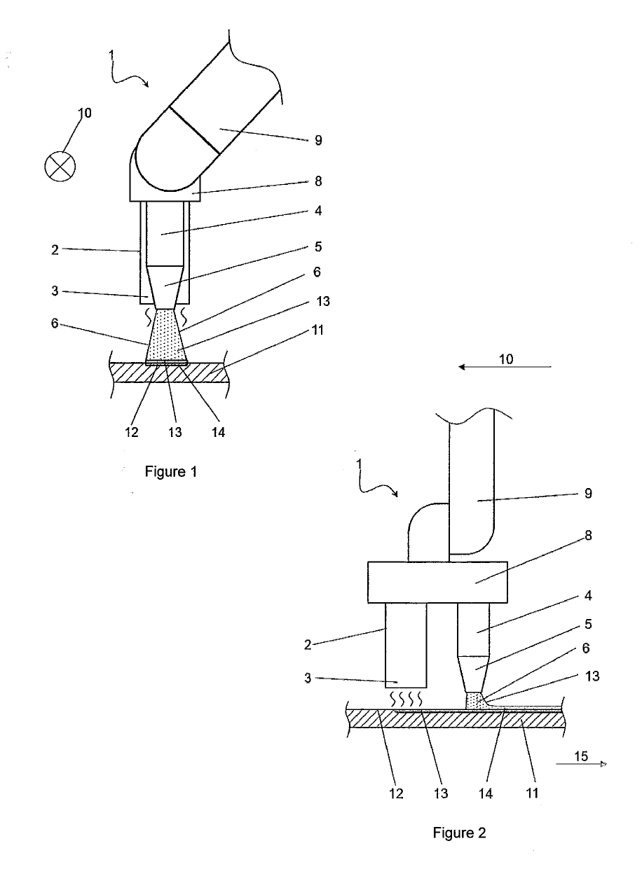

FIG. 1 is a sectional view through a first workpiece 11 and a rear view of a coating unit 1 for implementing a part of the method according to the invention for integrally bonding the depicted first workpiece 11 with a second workpiece 21 (not shown), The two workpieces 11, 21 consist of dissimilar thermoplastic polymers.

The first workpiece 11 consists of a partially crystalline polyethylene comprising a first edge layer 12. This is understood to mean a surface region of the first workpiece 11 that is intended to be integrally bonded to the second workpiece 21 (not shown) and is thus arranged in the region of the subsequent bonding zone. The edge layer 12 can have any shape and size and is adapted to the particular use and of course to the second workpiece 21. The coating unit 1 comprises a dosing device 4 for applying a primer 13 and a heating device 2 for preheating, immediately before the primer 13 is applied, the first edge layer 12 of the workpiece 11 to which said primer is intended to be applied.

The heating device 2 comprises a heating unit 3 which faces the surface of the workpiece 11 to be preheated, in order to preheat the first edge layer 12. The heating unit 3 is the nozzle portion of a hot gas apparatus (not shown in more detail) from which hot gas for preheating the first edge layer 12 can flow towards said edge layer. In the present embodiment, the preheating time, i.e. the time for which the hot gas flows onto the edge layer, is in the region of from 1 s-120 s, the temperature of the hot gas preferably being in the range of from 300° C.-450° C.

In the embodiment shown, the first edge layer 12 is preheated in such a way and for such a time that the temperature of the first edge layer is in the range between the initial peak temperature (T_{ini,m}) as the first limit and the initial stage temperature (T_{ini,z}) of the decomposition as the second limit. The initial peak temperature (T_{ini,m}) of the polyethylene used, for which the thermoplastic polymer is converted into a rubber-like to viscous melt, is 110° C. The initial stage temperature (T_{ini,z}) of the polyethylene from which the chemical composition of the polyethylene is damaged and from which said polyethylene begins to decompose, is 260° C. The first edge layer 12 is preferably preheated such that and for such a time that the workpiece is itself deformed at most in the region of the edge layer 12.

In this case, the preheating is carried out by means of a relative movement of the heating device 2 and the workpiece 11. For this purpose, in the embodiment shown, the workpiece 11 is held in the application position shown by a robot arm (not shown), an additional multiaxial robot arm 9 being provided, on which said heating device 2 is mounted via a holding device 8 and by means of which the heating device 2 for preheating the first edge layer 12 can be moved relative to the workpiece 11 in a movement direction 10. In the embodiment shown, the feed rate of the heating device 2 relative to the workpiece 11 is in the range of from 10 mm/min-100 m/min. Alternatively or additionally, it is also conceivable for the workpiece 11 to be able to be moved relative to the coating device 1 in particular by means of the above-mentioned robot arm (not shown). In the embodiment shown, the spacing of the heating element 3 from the surface of the workpiece 11 is in the range of from 10 mm to 40 mm. All parameters are matched to one another and adapted to the material of the first substrate such that the workpiece 11 is melted by the heating element 3 in a preheated region 14 of the first edge layer 12, the melt layer thickness produced in the preheated region 14 being in the range of from 0.1 mm to 3 mm. The heating device 2 further comprises a pyrometer (not shown), in order to continuously record the temperature of the first edge layer during the preheating. A control unit (not shown) is also provided to allow the preheating to be controlled using the recorded value.

The dosing device 4 is also mounted on the robot arm 9 via said holding device 8. The dosing device 4 comprises an application nozzle 5 for applying the primer 13 to the edge layer 12 of the workpiece 11, the primer 13 being applied here too by means of a relative movement of the dosing device 4 and the workpiece 11. In this case, the dosing device 4 and in particular the application nozzle 5 are designed such that not only can different primers 13 be applied but also different types of application can be selected. The primer 13 can thus be applied as a bead or sprayed on; however, application by means of thin-jet spraying as shown is also conceivable via an application jet.

In addition, the arrangement of the heating device 2 and the dosing device 4 is selected such that the edge layer 12 to which the primer 13 is applied is preheated immediately before said primer 13 is applied. The coating unit 1 is thus arranged and is moved relative to the workpiece 11 in the movement direction 10 such that, during the preheating of the workpiece 11, the heating element 4 is at a constant spacing, within the above-mentioned spacing range of from 10 mm to 40 mm, away from the outer surface of the workpiece 11, i.e. the edge layer 12. In addition, the heating element 3 is selected such that and the coating unit 1 is moved at such a speed, preferably a constant speed, relative to the workpiece 11 in the movement direction 10 that the edge layer 12 is within the area of the heating element 3 that is effective for heating the application region only within a specific time period. In this case, the coating unit 1 is moved relative to the workpiece 11 (which is in this case stationary) at a feed rate in the range of from 10 mm/min-100 m/min. By means of the heating unit 3, the edge layer 12 of the workpiece 11 is thus directly preheated in order to achieve melting, the preheated region 14 having a melt layer thickness in the range of from 0.1 mm-3 mm. The primer 13 is subsequently applied to the preheated region 14, i.e. directly on the molten material. The spacing between the dosing device 4 and the heating device 2 on the holding device 8 and the speed of the coating unit 1 in the movement direction 10 are thus adjusted such that the heating device 2, or rather said region of the heating unit 3 that is effective for heating, simultaneously leads the dosing device 2 during the movement of the coating unit 1 in the movement direction 10 at a time interval in the range of from 0.1 s-10 s in this case. Cooling of the application region after the preheating can thus be prevented, meaning that the primer 13 can be applied when the temperature of the preheated region 14 of the edge layer 12 is still sufficient. The primer 13 is thus applied when the preheated region 14 is still in the preheated and preferably still in the molten state, which leads to an integral connection between the preheated region 14 and the primer 13.

FIG. 2 is a cut side view of the coating unit 1 from FIG. 1 during the implementation of a part of the method according to the invention. A cut side view of the first workpiece 11 comprising the first edge layer 12, said preheated region 14, in regions, and the primer 13 applied to the preheated region 14, can also be seen. It can also be seen that both the heating device 2 comprising the heating unit 3 and the dosing device 4 comprising the application nozzle 5 are fastened together to the multiaxial robot 9 via the holding device 8. Accordingly, the heating device 2 and the dosing device 4 are moved in the movement direction 10 as a unit, the heating device 2 and the dosing device 4 being rigidly secured relative to one another with respect to their position during the process in order to be able to maintain a defined spacing between the heating device 2 and the dosing device 4 during a relative movement between the coating unit 1 and the workpiece 11. In this case, the holding device 8 may be further designed so as to be able to allow said components to be secured for the process and such that the spacing between the heating device 2 and the dosing device 4 can be modified by means of a linear drive or similar mechanical aid, for example, in particular in order to adapt the coating unit 1 when the workpiece 11 is changed, for example, and to design said coating unit to be able to be used in a flexible manner.

Of course, as mentioned above, an alternative or additional movement of the workpiece, for example in a movement direction 15, is also possible. By means of the constant movement of the sealing unit 1 and the defined spacing between the heating device 2 and the dosing device 4, the primer 13 is applied, for example using the above-mentioned parameters, by means of the application stream 6 via the application nozzle 5 when the preheated region 14 is still in the preheated and preferably still in the molten state, which leads to an integral connection between the preheated region 14 and the primer 13.

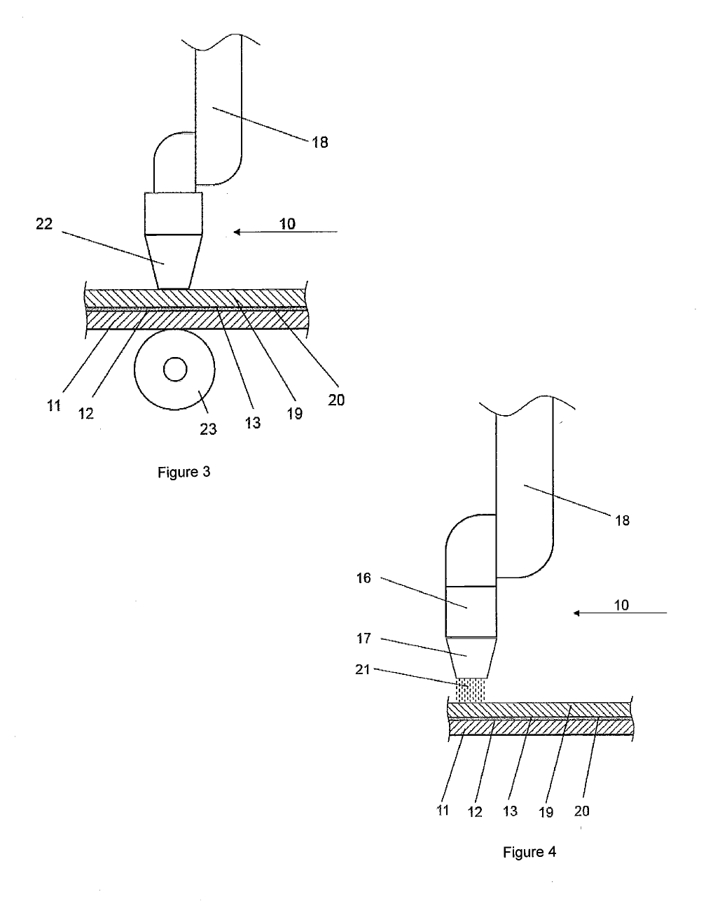

FIG. 3 is another side view of a welding device 16 during the implementation of another part of the method according to the invention. FIG. 3 also shows the first workpiece 11 having the primer 13 on the first edge layer 12. The second workpiece 19 made of a thermoplastic polymer and comprising a second layer 20 can also be seen here. It should be noted that the thermoplastic polymer of the second workpiece 19 is dissimilar with respect to the first workpiece 11. In the embodiment shown, a polyester is used as the second workpiece 19. In this case, the second workpiece 19 is brought into contact with the first workpiece 11 such that the first edge layer 12 provided with the primer 13 is arranged directly opposite the second edge layer 20. The two edge layers 12, 20 are thus separated from one another by the primer 13 applied to the first edge layer 12. The two workpieces 11, 19 are fixed in their position relative to one another. This can be carried out by brackets (not shown), in order to prevent the workpieces 11, 19 from slipping. In the embodiment shown, the welding device 16 is designed as an ultrasonic welding device and comprises a sonotrode 22 and a counter bearing 23. The sonotrode 22 is powered via an ultrasonic generator (not shown) having an ultrasonic vibration in a frequency range of from 15 kHz to 40 kHz, for example. The spacing between the sonotrode 22 and the counter bearing 23 is variable, in order to be able to weld workpieces 11, 19 having different total thicknesses. The welding device 16 makes it possible to produce an integral bond between the first edge layer 12 provided with the primer 13 and the second edge layer 20. The welding is carried out in a clocked or continuous manner by means of a relative movement of the welding device 16 and the connected workpieces 11, 19. In the embodiment shown, the workpiece 11, together with the second workpiece 19 secured thereto, is again held in the application position shown by a robot arm (not shown), a second, multiaxial robot arm 18 being provided, on which said welding device 16 comprising the sonotrode 22 and the counter bearing 23 is mounted and by means of which the welding device 16 can be moved in a movement direction 10. In the embodiment shown, the feed rate of the welding device 16 relative to the workpieces 11, 19 is in the range of from 10 mm/min-100 m/min. Alternatively or additionally, it is also conceivable, however, for the workpieces 11, 19 to be able to be moved relative to the welding device 16 in particular by means of the above-mentioned robot arm (not shown). All parameters are matched to one another and the workpieces 11, 19 and the primer 13 are adapted to one another such that the first workpiece 11 in the region of the first edge layer 12 provided with the primer 13 and the second workpiece 19 in the region of the second edge layer 12 are melted directly or even indirectly by the welding device 16, which leads to an integral connection between the first edge layer 12 equipped with the primer 13 and the second edge layer 20. As an alternative to the welding device 16 designed as an ultrasonic welding device, in particular a device suitable for vibration welding and/or heated tool welding can also be used, in order to allow an integral bond to be produced between the first edge layer 12 provided with the primer 13 and the second edge layer 20.

FIG. 4 is a side view of an alternative welding device 16 during the implementation of the part of the method according to the invention that has already been described. In this case too, the second workpiece 19 is brought into contact with the first workpiece 11 such that the first edge layer 12 provided with the primer 13 is arranged directly opposite the second edge layer 20. In the embodiment shown, the second workpiece 19 is a bonding partner that is transparent to a laser beam and the first workpiece 11 equipped with the primer 13 is an absorbent bonding partner. The welding device 16 comprises a laser light source (not shown) and a focusing optics 17 for a laser beam 21, which is used to produce an integral bond between the first edge layer 12 provided with the primer 13 and the second edge layer 20. Alternatively, polychromatic light from at least one IR radiator may also be used instead of the laser light. An advantage of the laser light used in this case is that the heat affected zone is minimal and easily controllable, meaning that thermal damage to the immediate surroundings can be prevented. The irradiation of the edge layers 12, 20 and the primer 13 by the laser beam 21 is carried out by means of a relative movement of the welding device 16 and the connected workpieces 11, 19. In the embodiment shown, the workpiece 11, together with the second workpiece 19 secured thereto, is again held in the application position shown by a robot arm (not shown), a second, multiaxial robot arm 18 being provided, on which said welding device 16 is mounted and by means of which the welding device 16 for irradiating the second edge layer 20 and the first edge layer 12 equipped with the primer 13 can be moved in the movement direction 10. Here too, the feed rate of the welding device 16 relative to the workpiece 11 is again in the range of from 10 mm/min-100 m/min. Alternatively or additionally, a movement of the workpieces 11, 19 is again also conceivable here. All parameters are matched to one another and the workpieces 11, 19 and the primer 13 are adapted to one another such that both the first workpiece 11 in the region of the first edge layer 12 provided with the primer 13 and the second workpiece 19 in the region of the second edge layer 12 are melted directly or even indirectly by the laser beam 21, which leads to an integral connection between the first edge layer 12 equipped with the primer 13 and the second edge layer 20.

List of reference signs:

| | |
|---|---|
| 1 | coating unit |
| 2 | heating device |
| 3 | heating unit |
| 4 | dosing device |
| 5 | application nozzle |
| 6 | application stream |
| 8 | holding device |
| 9 | robot arm |
| 10 | movement direction |
| 11 | workpiece |
| 12 | first edge layer |
| 13 | primer |
| 14 | preheated region |
| 15 | second movement direction |
| 16 | welding device |
| 17 | focusing optics |
| 18 | second robot arm |
| 19 | second workpiece |
| 20 | second edge layer |
| 21 | laser beam |
| 22 | sonotrode |
| 23 | counter bearing |

1. A method for integrally bonding two workpieces made of dissimilar thermoplastic polymers using a thermoplastic polymer primer as a connecting layer, comprising:
providing a first workpiece which is made of a thermoplastic polymer and comprises a first edge layer,
providing a second workpiece which is made of a thermoplastic polymer and comprises a second layer, wherein the thermoplastic polymer is dissimilar with respect to the thermoplastic polymer of the first workpiece,
preheating the first edge layer,
applying the primer to the preheated first edge layer, wherein the preheated first edge layer, while the primer is being applied, has a temperature in the range between the extrapolated onset of the glass transition temperature for amorphous plastics materials or the initial peak temperature of the melting range for partially crystalline plastics materials and the initial stage temperature of the decomposition of the thermoplastic polymer of the first edge layer,
bringing the first edge layer provided with the primer into contact with the second edge layer,
integrally bonding the first edge layer to the second edge layer.

2. The method according to claim 1, wherein the first edge layer is preheated such that the temperature of the first edge layer is in the range between the extrapolated onset of the glass transition temperature for amorphous plastics materials or the initial peak temperature of the melting range for partially crystalline plastics materials and the initial stage temperature of the decomposition of the thermoplastic polymer of the first edge layer.

3. The method according to claim 1, comprising continuously recording the temperature of the first edge layer during the preheating and continuously controlling the preheating step based on the recorded temperature.

4. The method according to claim 1, wherein the preheated first edge layer, while the primer is being applied, has a temperature that is lower than the decomposition temperature of the primer.

5. The method according to claim 1, wherein the first edge layer is heated during the step of applying the primer to the first edge layer.

6. The method according to claim 1, comprising the step of pretreating the first edge layer by at least one of corona discharge, plasma arc, flame treatment, radiation treatment, chemical treatment and mechanical treatment of the first edge layer before the first edge layer is preheated.

7. The method according to claim 1, wherein during the preheating step a melt layer is produced in the first edge layer, the melt layer having a thickness in the range of from 0.05 mm to 6 mm.

8. The method according to claim 1, wherein a heating device is used for preheating the first edge layer, the first edge layer being preheated during relative movement between the first workpiece and the heating device in the range of from 10 mm/min to 100 m/min.

9. The method according to claim 1, wherein:
the primer is applied to the first edge layer by a dosing device during relative movement between the first workpiece and the dosing device of from 10 mm/min to 100 m/min; and
the first edge layer to which the primer is applied is heated by means of a heating device during relative movement between the first workpiece and the heating device before the primer is applied, the heating device simultaneously leading the dosing device or a nozzle of the dosing device in order to apply the primer in a time interval in the range of from 0.1-10 s.

10. The method according to claim 1, wherein a heating device is used for preheating the first edge layer, the spacing between the heating device during the preheating and the first edge layer being in a range of from 0.5 mm to 100 mm.

11. The method according to claim 1, wherein thickness of the applied primer is in the range of from 1 μm to 5 mm.
